(19) United States
(12) Patent Application Publication
(10) Pub. No.: US 2016/0326047 A1
(43) Pub. Date: Nov. 10, 2016

(54) GLASS SHEET WITH ANTI-GLARE FUNCTION FOR SOLAR CELLS

(71) Applicant: ASAHI GLASS COMPANY, LIMITED, Chiyoda-ku (JP)

(72) Inventors: Satoshi MOTOTANI, Chiyoda-ku (JP); Yoshimi OTANI, Chiyoda-ku (JP); Mika KAMBE, Chiyoda-ku (JP)

(73) Assignee: ASAHI GLASS COMPANY, LIMITED, Chiyoda-ku (JP)

(21) Appl. No.: 15/214,941

(22) Filed: Jul. 20, 2016

Related U.S. Application Data
(63) Continuation of application No. PCT/JP2015/052381, filed on Jan. 28, 2015.

(30) Foreign Application Priority Data
Jan. 30, 2014 (JP) 2014-015668

(51) Int. Cl. C03C 17/30

(52) U.S. Cl. CPC C03C 17/30; C03C 2217/77; C03C 2218/112

(57) ABSTRACT

The object is to provide a glass sheet with anti-glare function for solar cells, having excellent anti-glare properties and having a high transmittance of sunlight. The glass sheet with anti-glare function for solar cells, comprises a glass sheet and an anti-glare layer formed on the glass sheet and having a surface roughness Ra of from 0.01 to 0.20 μm, wherein the matrix of the anti-glare layer is a hydrolytic polymerization product of an alkoxysilane.

### TECHNICAL FIELD

The present invention relates to a glass sheet with anti-glare function for solar cells.

### BACKGROUND ART

In a solar cell module, in order to protect the solar cell, a cover glass is placed on the front or back surface of the solar cell. For such a cover glass, a light weight thin glass sheet is used in order to reduce the load on the roof or the like for installation. Specifically, a sheet glass which is produced by a float method or a fusion method is used.

On the other hand, the solar cell module may have a problem that light pollution is caused by reflected light which is reflected by the surface of a cover glass, depending on the installation place. For example, when a solar cell module is installed on a sloping roof, there may be a case where reflected light which is reflected by the cover glass surface, enters into the neighboring buildings to cause light pollution.

As a method to suppress reflection of light at the surface of a glass sheet, a method is known to form irregularities on the surface of the glass sheet, so as to let light diffusely reflected by the irregularities. For example, in the case of a relatively thick glass sheet, there is a method to prepare a glass sheet having irregularities formed on the surface by a roll-out method using a roll having a pattern of irregularities formed on the outer circumferential surface. However, in the case of a thin glass sheet manufactured by a float method or a fusion method, it is not possible to form irregularities on the surface of the glass sheet during the production.

As a glass sheet with anti-glare function having irregularities formed on the surface of a glass sheet having a flat surface, for example, a glass sheet with anti-glare function is known wherein irregularities are formed on the surface by etching the surface of the glass sheet using a reagent such as hydrogen fluoride (for example, see Patent Document 1).

### PRIOR ART DOCUMENT

### Patent Document

Patent Document 1: JP-A-2013-14459

### DISCLOSURE OF INVENTION

### Technical Problem

However, the glass sheet with anti-glare function having the surface treated with hydrogen fluoride or the like, cannot still be said that its transmittance of solar light is sufficient. To increase the power generation efficiency of the solar cell module, it is necessary to increase the transmittance of sunlight of the cover glass, and it is important to obtain a glass sheet with anti-glare function having a higher transmittance of sunlight.

It is an object of the present invention to provide a glass sheet with anti-glare function for solar cells having excellent anti-glare properties and having a high transmittance of sunlight.

### Solution to Problem

The present invention provides a glass sheet with anti-glare function for solar cells having the following constructions [1] to [9].

[1] A glass sheet with anti-glare function for solar cells, which comprises a glass sheet, and an anti-glare layer (hereinafter referred to also as “AG layer”) formed on the glass sheet and having a surface roughness Ra of from 0.01 to 0.20 μm, wherein the matrix of the AG layer is a hydrolytic polymerization product of an alkoxysilane.
[2] The glass sheet with anti-glare function for solar cells according to the above [1], wherein the glossiness of the surface of the AG layer is at most 70.
[3] The glass sheet with anti-glare function for solar cells according to the above [1] or [2], which has a haze of at most 13%.
[4] The glass sheet with anti-glare function for solar cells according to any one of the above [1] to [3], wherein the refractive index at 550 nm of the AG layer is from 1.1 to 1.6.
[5] The glass sheet with anti-glare function for solar cells according to any one of the above [1] to [4], wherein the transmittance difference as defined below is larger than 0:

### [Transmittance Difference]

The difference between the transmittance of the glass sheet having the AG layer and the transmittance of the glass sheet not having the AG layer, obtainable by using a spectrophotometer with light having a wavelength of from 400 to 1,100 nm (incident perpendicular to the glass sheet at an incident angle of light being 0°):

Transmittance difference: Td=T1−T2 (1)

in the formula (1), T1 is the transmittance of the glass sheet having the AG layer, and T2 is the transmittance of the glass sheet only.
[6] The glass sheet with anti-glare function for solar cells according to any one of the above [1] to [5], wherein the coated amount of the matrix forming the AG layer is from 1.0 to 8.0 mg.
[7] The glass sheet with anti-glare function for solar cells according to any one of the above [1] to [6], wherein the thickness of the glass sheet is at most 1.9 mm.
[8] The glass sheet with anti-glare function for solar cells according to any one of the above [1] to [7], wherein the glass sheet is an aluminosilicate glass sheet.
[9] The glass sheet with anti-glare function for solar cells according to the above [8], wherein the aluminosilicate glass sheet is chemically tempered.

### Advantageous Effects of Invention

The glass sheet with anti-glare function for solar cells of the present invention has excellent anti-glare properties and has a high transmittance of sunlight.

### DESCRIPTION OF EMBODIMENTS

The glass sheet with anti-glare function for solar cells of the present invention (hereinafter referred to also as the glass sheet with anti-glare function) is a glass sheet to be used as a cover glass for the front surface of a solar cell module.

The glass sheet with anti-glare function of the present invention comprises a glass sheet and an AG layer formed on the glass sheet.

[Glass Sheet]

The material for the glass sheet may, for example, be soda lime glass, aluminosilicate glass, alkali-free glass, borosilicate glass, quartz glass, etc. Among them, aluminosilicate glass is preferred, since it can readily be made into a glass sheet light in weight with high strength by chemical tempering treatment.

Here, an aluminosilicate glass sheet made of aluminosilicate glass, is glass comprising aluminum oxide and silicon dioxide, as main components, and containing, as other components, MgO, Na₂O, K₂O, ZrO₂, etc. As a typical composition, a glass sheet made of glass comprising from 6 to 20 mol % of Al₂O₃ and from 62 to 68 mol % of SiO₂ and containing, as other components, from 7 to 13 mol % of MgO, from 9 to 17 mol % of Na₂O, from 0 to 7 mol % of K₂O and from 0 to 8 mol % of ZrO₂ may be mentioned, but the glass composition is not limited to such a typical composition.

As the glass sheet, a tempered glass sheet is preferred, and a chemically tempered glass sheet is more preferred, since the strength is high and, as a thin glass sheet, the solar cell module can be made light in weight.

Chemical tempering is carried out by immersing a glass sheet in a molten salt at a temperature of at most the strain point temperature of the glass to change ions (e.g. sodium ions) at the glass sheet surface layer to ions having a larger ionic radius (e.g. potassium ions in the molten salt). Thus, a compressive stress layer is formed at the surface layer in the glass sheet, and by the compressive stress layer, the strength of the glass sheet against scratches or impacts will be improved.

As such tempered glass, a chemically tempered aluminosilicate glass sheet is preferred, in that it can easily be chemically tempered, and even when it is made to be thin, high strength can easily be obtainable.

The thickness of the glass sheet is preferably at most 1.9 mm, more preferably from 0.4 to 1.3 mm, further preferably from 0.5 to 1.1 mm. When the thickness of the glass sheet is at least the above lower limit value, the glass sheet tends to be less likely to be deflected, and the handling efficiency will be good. When the thickness of the glass sheet is at most the above upper limit value, the absorption of light can be kept low, and a high transmittance can be easily obtainable. Further, the glass sheet is made light in weight, whereby the weight of the solar cell module can be significantly reduced.

As the glass sheet, a chemically tempered aluminosilicate glass sheet having a thickness of at most 1.9 mm is particularly preferred, since it has high strength and is excellent in durability against physical impact, and it is light in weight and can be installed even on e.g. a roof, etc. having a relatively low load-bearing ability.

[AG Layer]

The AG layer plays a role of suppressing reflection of sunlight by diffusely reflecting sunlight at the surface.

The AG layer contains a hydrolytic polymerization product of an alkoxysilane as a matrix. As the matrix of the AG layer is a hydrolytic polymerization product of an alkoxysilane, the refractive index of the AG layer tends to be low. Therefore, by making the AG layer to satisfy the condition for the surface roughness Ra as described below, the transmittance of sunlight will be improved by an optical interference effect.

The alkoxysilane may, for example, be tetramethoxysilane, tetraethoxysilane, tetrapropoxysilane, methyltrimethoxysilane, ethyltriethoxysilane, etc.

The AG layer may contain fine silica particles. The fine silica particles may, for example, be solid fine silica particles, porous fine silica particles, hollow fine silica particles, etc.

In a case where the AG layer contains fine silica particles, the ratio of the fine silica particles by mass calculated as SiO₂ to the total solid content by mass calculated as SiO₂ in the film is preferably from 0.1 to 80 mass %, more preferably from 1 to 70 mass %. When the ratio is at least the above lower limit value, the AG effect will be sufficiently exhibited, even if the surface roughness Ra of the AG layer is made small. When the ratio is at most the above upper limit value, the adhesion strength between the AG layer and the glass sheet tends to be high.

The fine silica particles may contain metal(s) other than Si. Other metal(s) may, for example, be Al, Cu, Ce, Sn, Ti, Cr, Co, Fe, Mn, Ni, Zn, Zr, etc. Other metal(s) may be contained as metal oxide(s), or may form a composite oxide together with Si.

The average primary particle size of the fine silica particles is preferably from 0.01 to 3 μm, more preferably from 0.04 to 2 μm.

The AG layer may contain component(s) other than the matrix and fine silica particles. Such other component(s) may, for example, be a matrix and fine particles containing, as a component, metal oxide(s) such as titania, zirconia, alumina, indium tin oxide (ITO), antimony tin oxide (ATO), etc., metal particles, inorganic pigments, etc.

The surface roughness Ra of the AG layer is from 0.01 to 0.20 μm. As an AG layer is formed so that the surface roughness Ra satisfies the above range, it is possible to obtain good anti-glare properties, and the transmittance of sunlight will be high.

The surface roughness Ra of the AG layer is preferably from 0.02 to 0.15 μm. When the surface roughness Ra of the AG layer is at least the above lower limit value, it is easy to increase the transmittance of sunlight. When the surface roughness Ra of the AG layer is at most the above upper limit value, it is easy to obtain good anti-glare properties.

Here, the surface roughness Ra of the AG layer is an arithmetic average roughness as measured in accordance with JIS B0601 (2001).

The glossiness of the surface of the AG layer is an index for AG effects. The glossiness of the surface of the AG layer is preferably at most 70, more preferably at most 60.

In the present invention, the glossiness of the surface of the AG layer means glossiness of the AG layer having an influence of back surface reflection of the glass sheet eliminated. The glossiness of the surface of the AG layer is a value measured by a method as defined in 60° specular gloss of JIS Z8741 (1997), upon taking measures to eliminate an influence of back surface reflection of the glass sheet.

The refractive index of the AG layer is preferably from 1.1 to 1.6, more preferably from 1.2 to 1.5. When the refractive index of the AG layer is at least the above lower limit value, it is easy to obtain sufficient AG effects. When the refractive index of the AG layer is at most the above upper limit value, the transmittance of sunlight tends to be high.

The refractive index is meant for a refractive index at 550 nm and is measured by a refractometer.

[Haze]

The haze of the glass sheet with anti-glare function of the present invention is preferably at most 13%, more preferably at most 11%. When the haze is at most the above upper limit value, the power generation efficiency of the solar cell module will be high.

The haze is measured in accordance with JIS K7105 (1981) by using a commercially available haze meter.

[Production Method]

The method for producing a glass sheet with anti-glare function of the present invention is not particularly limited. For example, a method may be mentioned wherein a coating solution comprising a hydrolytic polymerization product of an alkoxysilane and a dispersion medium as essential components and containing other components such as fine silica particles as the case requires, is applied on a heated glass sheet by a spraying method, followed by heating for aging.

The dispersion medium in the coating solution may, for example, be water, an alcohol (methanol, ethanol, isopropanol, etc.), a ketone (acetone, methyl ethyl ketone, etc.), an ether (tetrahydrofuran, 1,4-dioxane, etc.), an ester (ethyl acetate, methyl acetate, etc.), a glycol ether (ethylene glycol monoalkyl ether, etc.), a nitrogen-containing compound (N,N-dimethylacetamide, N,N-dimethylformamide, etc.), a sulfur-containing compound (dimethyl sulfoxide, etc.), etc.

The solid content concentration in the coating solution is preferably from 1 to 5 mass %, more preferably from 2 to 4 mass %. When the solid content concentration in the coating solution is at least the above lower limit value, it is easy to form an AG layer showing sufficient AG effects. When the solid content concentration in the coating solution is at most the above upper limit value, control of the film thickness of the AG layer will be easy.

The nozzle in a spray apparatus to be used in a spraying method may, for example, be two-fluid spray nozzles, a one-fluid spray nozzle, etc.

The surface roughness Ra of the AG layer to be formed, can be controlled by adjusting the droplet diameter of the coating solution to be sprayed, the distance between the spray nozzle tip and the glass sheet, the number of coatings by spraying (i.e. number of coating times), the heating temperature of the glass sheet, etc. For example, as the number of coating times increases, the surface roughness Ra tends to be large. As the droplet diameter of the coating solution becomes large, the surface roughness Ra tends to be large.

The droplet diameter of the coating solution may suitably be adjusted by the type of the spray nozzle, the spraying pressure, the liquid amount, etc. For example, two-fluid nozzles may be preferably used, whereby a liquid and a gas are mixed and sprayed in the form of a fine mist, so that liquid droplets become small as the spraying pressure becomes high, and the liquid droplets become large as the liquid amount increases.

The spraying pressure is preferably from 0.1 to 0.7 MPa, more preferably from 0.2 to 0.5 MPa.

The distance between the spray nozzle tip and the glass sheet during spraying of the coating solution on the glass sheet is preferably from 80 to 300 mm, more preferably from 100 to 200 mm. When the distance between the spray nozzle tip and the glass sheet is within the above range, it is easy to form an AG layer excellent in anti-glare properties.

The heating temperature of the glass sheet at the time of applying the coating solution to the glass sheet surface is preferably from 30 to 100° C., more preferably from 40 to 95° C. When the heating temperature of the glass sheet is at least the above lower limit value, the dispersion medium evaporates quickly, whereby formation of an AG layer is facilitated. When the heating temperature of the glass sheet is at most the above upper limit value, it is easy to form an AG layer having good adhesion to the glass sheet.

The coated amount of the matrix of the coating solution that forms the AG layer is preferably 1.0 to 8.0 mg, more preferably from 1.3 to 7.8 mg, more preferably from 2.0 to 7.0 mg. When the coated amount of the matrix is in the above range, it tends to be easy to obtain a glass sheet with anti-glare function having excellent anti-glare properties and having a high transmittance of sunlight. When the coated amount of the matrix is at least the above lower limit value, it is easy to form an AG layer having excellent anti-glare properties. When the coated amount of the matrix is at most the above upper limit value, it tends to be easy to obtain a glass sheet with anti-glare function having a high transmittance of sunlight.

Here, the coated amount of the matrix to form the layer AG in the present invention is a dried weight of the matrix coated on a glass sheet with a size of 100 mm×100 mm, and the details will be described later.

At the time of applying the coating solution to the glass sheet surface, a heated thermal insulation sheet may be disposed under the glass sheet, to prevent a temperature drop of the glass sheet.

At the time of conducting heat aging of the coating layer after application of the coating solution, the heat aging temperature is preferably from 100 to 700° C., more preferably from 200 to 700° C.

Further, in the coating solution, a substance to impart water repellency to the AG layer, or a substance to impart hydrophilicity to the AG layer, may be added. The glass sheet with anti-glare function may thereby be made to be stain-resistant, or even if stained, such a stain may be easily removed by e.g. rainwater.

Further, one or a plurality of functional additive layers, such as antireflection films, antifouling films, etc., may be formed on the AG layer within a range not impair the glass sheet with anti-glare function of the present invention.

[Advantageous Effects]

In the glass sheet with anti-glare function of the present invention as described above, an AG layer containing a hydrolytic polymerization product of an alkoxysilane as a matrix and having the surface roughness Ra controlled to be within the specific range, is formed, whereby excellent anti-glare properties and a high transmittance of sunlight are satisfied at the same time. Therefore, by using the glass sheet with anti-glare function of the present invention, it is possible to suppress light pollution due to reflection of sunlight, and it is possible to increase the power generation efficiency of a solar cell module.

In particular, even in the case of using an aluminosilicate glass sheet whereby the transmittance tends to be lower than that of soda lime glass, it becomes possible to increase the transmittance of sunlight by forming an AG layer having the surface roughness Ra controlled to be within the specific range. Therefore, by using an aluminosilicate glass sheet which can easily be highly chemically tempered, it is possible to obtain a glass sheet with anti-glare function which is excellent in anti-glare properties and has a high transmittance of sunlight, and which is further light in weight and excellent in durability.

### EXAMPLES

Now, the present invention will be described in detail with reference to Examples, but the present invention is by no means restricted by the following description. Ex. 1 to 6 are Examples of the present invention, and Ex. 7 to 10 are Comparative Examples.

[Glossiness]

The glossiness of the surface of an AG layer was measured at approximately the center of the AG layer by a method as defined in 60° specular glossiness of JIS Z8741 (1997) by means of a gloss meter (PG-3D model, manufactured by Nippon Denshoku

Industries Co. Ltd.). Here, the glossiness of the surface of the AG layer was measured in such a state that an influence of reflection on the back surface of the glass is eliminated by attaching a black tape to the back surface (the surface on the opposite side of the AG layer) of the glass sheet.

[Haze]

The haze was measured at approximately the center of the glass sheet by means of a haze meter (HM150L2 model, manufactured by Murakami Color Research Laboratory).

[Transmittance Difference]

By means of a spectrophotometer (V670, manufactured by JASCO Corporation), with respect to light having a wavelength of 400 to 1,100 nm, the transmittance of the glass sheet with anti-glare function obtained in each Ex. and the transmittance of a chemically tempered glass sheet having no AG layer formed (trade name “Leoflex”, manufactured by Asahi Glass Company, Limited) were measured, and the transmittance difference Td was obtained by the following equation (1). The angle of incidence of the light was set to be 0° (incident perpendicular to the glass sheet).

TD=T1−T2 (1)

In the formula (1), T1 is the transmittance of the glass sheet with anti-glare function, and T2 is the transmittance of the chemically tempered glass sheet only.

[Anti-glare Properties]

For the anti-glare properties, a black tape was pasted on the back surface (the surface opposite to the AG layer) of the glass sheet, and the extent to which fluorescent light was reflected on the AG layer surface was visually observed and evaluated by the following standards.

⊚: No fluorescent light is observed.

◯: Fluorescent light is blurred to show sufficient anti-glare properties.

Δ: Glare of fluorescent light is conspicuous.

x: Fluorescent light can be seen clearly.

[Refractive Index]

With a view to obtaining the refractive index of the material itself of an AG layer, by avoiding a spray coating method to form a layer of a scattering structure, a thin film was prepared on a glass sheet surface using the above-described coating solution by a spin coating method not to form a layer of a scattering structure, and the refractive index was measured by means of a reflectance spectroscopic film thickness meter “FE3000” manufactured by Otsuka Electronics Co., Ltd. The refractive index of the thin film of the material itself of the layer forming the AG layer was 1.46.

[Coated Amount of Matrix Forming AG Layer]

The following two types of glass sheets A and B were prepared.

A: A glass sheet having an AG layer formed on a rectangular glass sheet of 100 mm×100 mm (thickness: 0.85 mm) by the method described in Examples.

B: A glass sheet aged under the same conditions as those described in Examples without forming an AG layer.

The mass of each glass sheet was measured by an electronic balance, and the difference was obtained. The same procedure was repeated a number of times n=5, and the average value was taken as the coated amount of the matrix.

[Materials Used]

(Preparation of Silica-type Matrix Solution (a-1))

While stirring 75.8 g of modified ethanol (trade name “Solmix AP-11”, manufactured by Japan Alcohol Trading Co., Ltd.; a mixed solvent containing ethanol as the main material; the same applies hereinafter), a mixed solution of 11.9 g of ion-exchanged water and 0.1 g of 61 mass % nitric acid was added, followed by stirring for 5 minutes. 12.2 g of tetraethoxysilane (solid content concentration calculated as SiO₂: 29 mass %): was added thereto, followed by stirring for 30 minutes at room temperature, to prepare a silica-type matrix solution (a-1) having a solid content concentration calculated as SiO₂ of 3.5 mass %.

Here, the solid content concentration calculated as SiO₂ is a solid content concentration when all Si of tetraethoxysilane was converted to SiO₂.

(Preparation of Silica-type Matrix Solution (a-2))

While stirring 80.3 g of modified ethanol, a mixed solution of 7.9 g of ion-exchanged water and 0.2 g of 61 mass % nitric acid was added, followed by stirring for 5 minutes. Then, 11.6 g of 1,6-bis(trimethoxysilyl)hexane (trade name “KBM3066”, manufactured by Shin-Etsu Silicone Co., Ltd., solid content concentration calculated as SiO₂: 37 mass %) was added, followed by stirring at 60° C. for 15 minutes in a water bath, to prepare a silica-type matrix solution (a-2) having a solid content concentration calculated as SiO₂ of 4.3 mass %.

### (Preparation of Coating Solution)

While stirring 77.1 g of the silica-type matrix solution (a-1), 7.0 g of the silica-type matrix solution (a-2) was added, followed by stirring for 30 minutes. Then, 15.9 g of modified ethanol was added, followed by stirring for 30 minutes at room temperature, to obtain a coating solution (A) having a solid content concentration calculated as SiO₂ of 3.0 mass %.

[Ex. 1]

### (Cleaning of Glass Sheet)

As a glass sheet, a chemically tempered aluminosilicate glass sheet (trade name “Leoflex”, manufactured by Asahi Glass Company, Limited, size: 300 mm×300 mm, thickness: 0.85 mm) was prepared. The surface of the glass sheet was cleaned with a sodium hydrogen carbonate solution, then rinsed with deionized water, and dried.

(Preparation of Glass Sheet with Anti-glare Function)

The above glass sheet was preheated by a preheating furnace (VTR-115, manufactured by ISUZU). Then, in such a state that the surface temperature of the glass sheet was kept at 80° C., the coating solution (A) was applied onto the above glass sheet under the following conditions, so that the surface roughness Ra would be as shown in Table 1.

Spraying pressure: 0.2 MPa,

Movement speed of nozzle: 750 mm/min,

Spray pitch: 22 mm.

Then, aging was conducted in the atmosphere at 200° C. for 3 minutes, to obtain a glass sheet with anti-glare function having an AG layer.

For the application by a spray method, a six-axis coating robot (JF-5, manufactured by Kawasaki Robotics Inc.) was used. Further, as the nozzle 20, VAU nozzle (two-fluid nozzle, manufactured by Spraying Systems Japan Co.) was used. The surface roughness Ra of the AG layer was measured in accordance with J IS B0601 (2001).

[Ex. 2 to 8]

A glass sheet with anti-glare function was obtained in the same manner as in Ex. 1 except that the surface roughness Ra was changed as shown in Table 1.

[Ex. 9]

For comparison, a chemically tempered aluminosilicate glass sheet (trade name “Leoflex”, manufactured by Asahi Glass Company, Limited, size: 300 mm×300 mm, thickness: 0.85 mm) was used for evaluation as it was.

[Ex. 10]

A glass sheet (trade name “LST110”, manufactured by Asahi Glass Company,

Limited, soda-lime glass sheet) having the surface anti-glare treated by etching with a hydrofluoric acid solution was used for evaluation.

The evaluation results in each Ex. are shown in Table 1.

TABLE 1

| | Surface | Coating | Glossiness | | Transmit- | Anti- |
|---|---|---|---|---|---|---|
| | roughness | amount of | of surface | | tance | glare |
| | Ra of AG | matrix | of AG | Haze | difference | prop- |
| | layer [μm] | [mg] | layer | [%] | Td [%] | erties |
| Ex. 1 | 0.06 | 1.30 | 61 | 2.7 | 0.46 | Δ |
| Ex. 2 | 0.07 | 2.61 | 48 | 4.0 | 0.54 | ◯ |
| Ex. 3 | 0.11 | 3.91 | 36 | 6.5 | 0.49 | ◯ |
| Ex. 4 | 0.15 | 5.21 | 29 | 7.8 | 0.10 | ◯ |
| Ex. 5 | 0.16 | 6.52 | 28 | 9.9 | 0.11 | ◯ |
| Ex. 6 | 0.19 | 7.82 | 27 | 11.0 | 0.08 | ⊚ |
| Ex. 7 | 0.22 | 10.42 | 20 | 13.8 | −0.23 | ⊚ |
| Ex. 8 | 0.26 | 13.03 | 15 | 20.4 | −1.04 | ⊚ |
| Ex. 9 | — | — | 92 | 0.1 | 0 | X |
| Ex. 10 | — | — | 65 | 1.7 | −0.10 | ◯ |

As shown in Table 1, in the case of the glass sheet with anti-glare function in each of Ex. 1 to 6 having an AG layer with a surface roughness Ra in a range of from 0.01 to 0.20 μm, as compared with the glass sheet with anti-glare function in Ex. 9 having no AG layer, the glossiness of the surface of the AG layer was low, it had excellent anti-glare properties, the transmittance difference Td was a positive value, and the transmittance was improved. Further, in the case of the glass sheet with anti-glare function in each of Ex. 1 to 6, the haze was also sufficiently low.

On the other hand, in the case of the glass sheet with anti-glare function in each of Ex. 7 and 8 having an AG layer formed not to satisfy the surface roughness Ra in the range of the present invention, although excellent anti-glare properties were obtained, the transmittance difference Td was negative in the value, and the transmittance was reduced.

Further, in the case of the glass sheet in Ex. 10 anti-glare treated by etching with a hydrofluoric acid solution, although excellent anti-glare properties were obtained, the transmittance difference Td was negative in the value, and the transmittance was reduced.

### INDUSTRIAL APPLICABILITY

According to the present invention, since an AG layer is formed which contains a hydrolytic polymerization product of an alkoxysilane as a matrix and which has a surface roughness Ra controlled to be within the specific range, it is possible to provide a glass sheet with anti-glare function which satisfies both excellent anti-glare properties and a high transmittance of sunlight. Accordingly, by using the glass sheet with anti-glare function of the present invention as a cover glass sheet for a solar cell, it is possible to suppress light pollution due to reflection of sunlight, and it is possible to increase the power generation efficiency of the solar cell module.

This application is a continuation of PCT Application No. PCT/JP2015/052381 filed on Jan. 28, 2015, which is based upon and claims the benefit of priority from Japanese Patent Application No. 2014-015668 filed on Jan. 30, 2014. The contents of those applications are incorporated herein by reference in their entireties.

What is claimed is:

1. A glass sheet with anti-glare function for solar cells, which comprises a glass sheet, and an anti-glare layer formed on the glass sheet and having a surface roughness Ra of from 0.01 to 0.20 μm, wherein the matrix of the anti-glare layer is a hydrolytic polymerization product of an alkoxysilane.

2. The glass sheet with anti-glare function for solar cells according to claim 1, wherein the glossiness of the surface of the anti-glare layer is at most 70.

3. The glass sheet with anti-glare function for solar cells according to claim 1, which has a haze of at most 13%.

4. The glass sheet with anti-glare function for solar cells according to claim 1, wherein the refractive index at 550 nm of the anti-glare layer is from 1.1 to 1.6.

5. The glass sheet with anti-glare function for solar cells according to claim 1, wherein the transmittance difference as defined below is larger than 0:
[Transmittance difference]
The difference between the transmittance of the glass sheet having the anti-glare layer and the transmittance of the glass sheet not having the anti-glare layer, obtainable by using a spectrophotometer with light having a wavelength of from 400 to 1,100 nm (incident perpendicular to the glass sheet at an incident angle of light being 0°):
Transmittance difference: Td=T1−T2 (1)
in the formula (1), T1 is the transmittance of the glass sheet having the anti-glare layer, and T2 is the transmittance of the glass sheet only.

6. The glass sheet with anti-glare function for solar cells according to claim 1, wherein the coated amount of the matrix forming the anti-glare layer is from 1.0 to 8.0 mg (wherein the coated amount of the matrix is the dried weight of the matrix coated in a size of 100 mm×100 mm on the glass sheet).

7. The glass sheet with anti-glare function for solar cells according to claim 1, wherein the thickness of the glass sheet is at most 1.9 mm.

8. The glass sheet with anti-glare function for solar cells according to claim 1, wherein the glass sheet is an aluminosilicate glass sheet.

9. The glass sheet with anti-glare function for solar cells according to claim 8, wherein the aluminosilicate glass sheet is chemically tempered.
